(19) United States
(12) Patent Application Publication
(10) Pub. No.: US 2024/0370023 A1
(43) Pub. Date: Nov. 7, 2024

(54) METHOD AND APPARATUS FOR CONTROLLING FLIGHT ASSEMBLY, TERMINAL, AND READABLE STORAGE MEDIUM

(71) Applicant: VIVO MOBILE COMMUNICATION CO., LTD., Dongguan (CN)

(72) Inventor: Lei LI, Dongguan (CN)

(73) Assignee: VIVO MOBILE COMMUNICATION CO., LTD., Dongguan (CN)

(21) Appl. No.: 18/773,769

(22) Filed: Jul. 16, 2024

Related U.S. Application Data
(63) Continuation of application No. PCT/CN2023/073405, filed on Jan. 20, 2023.

(30) Foreign Application Priority Data
Jan. 26, 2022 (CN) 202210093579.5

(51) Int. Cl. G05D 1/223; G06F 3/0354

(52) U.S. Cl. CPC G05D 1/223; G06F 3/03545

(57) ABSTRACT

A method and an apparatus for controlling a flight assembly, a terminal, and a readable storage medium are disclosed. The flight assembly is movably disposed inside a terminal, the terminal is provided with an outlet for the flight assembly to move out of the terminal, and the method includes: displaying a control on the terminal in response to a first input performed by a touch object on the terminal; controlling, in response to a second input performed by the touch object on the control, the flight assembly to move towards the outlet of the terminal; and controlling a flight action of the flight assembly according to an action of the touch object after the flight assembly moves out of the terminal.

### CROSS-REFERENCE TO RELATED APPLICATIONS

This application is a continuation of International Application No. PCT/CN2023/073405, filed on Jan. 20, 2023, which claims priority to Chinese Patent Application No. 202210093579.5, filed Jan. 26, 2022. The entire contents of each of the above-identified applications are expressly incorporated herein by reference.

### TECHNICAL FIELD

This application pertains to the field of electronic technologies, and specifically relates to a method and an apparatus for controlling a flight assembly, a terminal, and a readable storage medium.

### BACKGROUND

With rapid popularization of terminal devices such as a mobile phone and a tablet computer, a camera is disposed on a terminal is various manners, and many novel disposing ideas appear. In an existing idea of disposing a camera, a lifting camera and an unmanned aerial vehicle may be combined. When a camera is ejected from a mobile phone, a propeller on the camera rotates, and the camera may serve as a small unmanned aerial vehicle to fly away from a body of the mobile phone, thereby implementing more flexible photographing. However, in an existing implementation manner of a flight assembly, control of the flight assembly by the user is not flexible enough.

### SUMMARY

Embodiments of this application provide a method and an apparatus for controlling a flight assembly, a terminal, and a readable storage medium.

According to a first aspect, an embodiment of this application provides a method for controlling a flight assembly. The flight assembly is movably disposed inside a terminal, the terminal is provided with an outlet for the flight assembly to move out of the terminal, and the method includes: displaying a control on the terminal in response to a first input performed by a touch object on the terminal; controlling, in response to a second input performed by the touch object on the control, the flight assembly to move towards the outlet; and controlling a flight action of the flight assembly according to an action of the touch object after the flight assembly moves out of the terminal.

According to a second aspect, an embodiment of this application provides an apparatus for controlling a flight assembly. The flight assembly is movably disposed inside a terminal, the terminal is provided with an outlet for the flight assembly to move out of the terminal, and the apparatus includes: a first response module, configured to display a control on the terminal in response to a first input performed by a touch object on the terminal; a second response module, configured to control, in response to a second input performed by the touch object on the control, the flight assembly to move towards the outlet; and a flight control module, configured to control a flight action of the flight assembly according to an action of the touch object after the flight assembly moves out of the terminal.

According to a third aspect, an embodiment of this application provides a terminal. The terminal includes a processor and a memory, where the memory stores a program or an instruction that can be run on the processor, and the program or the instruction is executed by the processor to implement the method for controlling a flight assembly according to the first aspect.

According to a fourth aspect, an embodiment of this application provides a readable storage medium. The readable storage medium stores a program or an instruction, and the program or the instruction is executed by a processor to implement the method for controlling a flight assembly according to the first aspect.

According to a fifth aspect, an embodiment of this application provides a chip. The chip includes a processor and a communication interface, the communication interface is coupled to the processor, and the processor is configured to run a program or an instruction to implement the method according to the first aspect.

According to a sixth aspect, an embodiment of this application provides a computer program product. The program product is stored in a storage medium, and the program product is executed by at least one processor to implement the method according to the first aspect.

In the embodiments of this application, the flight assembly is controlled based on the touch object; the control is displayed on the terminal in response to the first input performed by the touch object on the terminal; in response to the second input performed by the touch object on the control, the flight assembly is controlled to move towards the outlet; and the flight assembly is controlled to perform the corresponding flight action according to the action of the touch object after the flight assembly moves out of the terminal.

### BRIEF DESCRIPTION OF DRAWINGS

FIG. 1 is a flowchart of a method for controlling a flight assembly according to an embodiment of this application;

FIG. 2 is a schematic diagram of a flight assembly according to an embodiment of this application;

FIG. 3 is a schematic diagram of a window interface according to an embodiment of this application;

FIG. 4 is a schematic diagram of a coordinate system of a stylus according to an embodiment of this application;

FIG. 5 is a schematic diagram of a coordinate system of a flight assembly according to an embodiment of this application;

FIG. 6 is a schematic diagram of setting a target axis of a flight assembly according to an embodiment of this application;

FIG. 7 is a block diagram of an apparatus for controlling a flight assembly according to an embodiment of this application;

FIG. 8 is a schematic diagram of a terminal according to an embodiment of this application; and

FIG. 9 is a schematic diagram of an electronic device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

With reference to the accompanying drawings, the following describes in detail a method for controlling a flight assembly provided in the embodiments of this application by using specific embodiments and application scenes thereof.

Before the method for controlling a flight assembly in the embodiments of the present disclosure is described, a terminal, a touch object, and a flight assembly are first described by using examples.

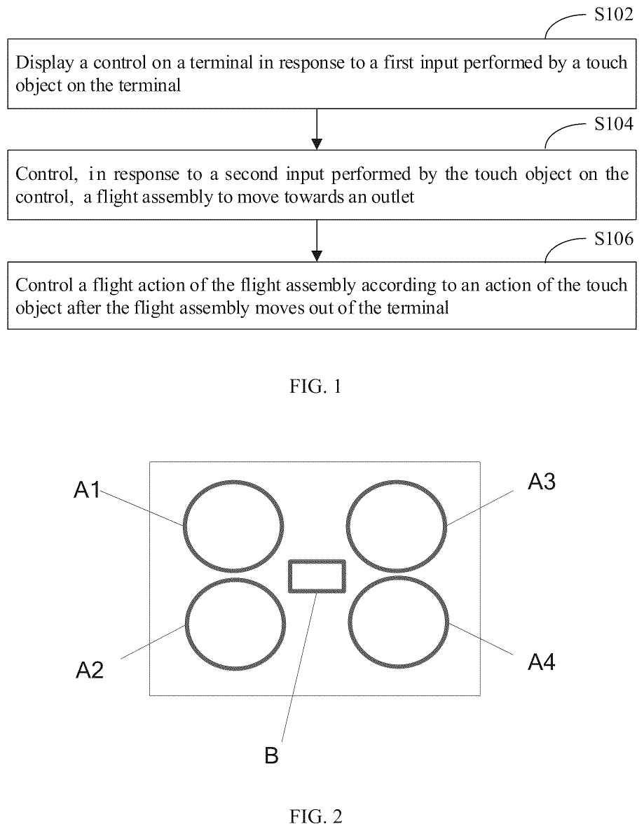

In an embodiment of this application, the flight assembly includes a support, a battery mounted on the support, a drive mechanism, a camera, a first wireless communication module, a processor, and a memory. The drive mechanism may drive the flight assembly to translate, lift, and rotate. In an example, referring to FIG. 2, the drive mechanism includes a propeller A1, a propeller A2, a propeller A3, a propeller A4, and a plurality of motors that drive the propeller A1, the propeller A2, the propeller A3, and the propeller A4. A camera B is mounted in the middle of the four propellers. The flight assembly is further provided with sensors such as an acceleration sensor and a gyroscope. Through these sensors, movement and rotation of the flight assembly may be detected, to determine an attitude of the flight assembly.

In an embodiment of this application, the terminal includes a housing, a touchscreen, a second wireless communication module, a processor, and a memory. The housing is provided with an outlet for the flight assembly to move in and out. The flight assembly may be movably disposed inside the terminal, and the flight assembly may be moved from the inside of the terminal to the outside of the terminal through the outlet, and is detached from the terminal on an entity. The terminal may be, for example, a mobile phone, a tablet computer, or a notebook computer.

In an embodiment of this application, the stylus is provided with sensors such as an acceleration sensor and a gyroscope. Through these sensors, movement and rotation of the stylus may be detected, to determine an attitude of the stylus. The stylus is provided with a third wireless communication module, a processor, and a memory.

The first wireless communication module, the second wireless communication module, and the third wireless communication module support information interaction between the terminal, the stylus, and the flight assembly. In some implementations, the stylus may exchange information with the flight assembly by using the terminal.

In an embodiment of this application, the touch object may be a user. A wearable device may be worn on the user, and an action of the user may be detected based on a sensing signal output by the sensor in the wearable device. For example, the wearable device is provided with sensors such as an acceleration sensor and a gyroscope. Through these sensors, a translation action or a rotation action of the user may be detected. The wearable device is provided with a fourth wireless communication module, a processor, and a memory. The wearable device may be, for example, a smart watch or a smart band.

The first wireless communication module, the second wireless communication module, and the fourth wireless communication module support information interaction between the terminal, the wearable device, and the flight assembly. In some implementations, the wearable device may exchange information with the flight assembly by using the terminal.

Referring to FIG. 1, FIG. 1 is a schematic flowchart of a method for controlling a flight assembly according to an embodiment of this application. As shown in FIG. 1, the method may include steps S102 to S106, which are described in detail below.

Step S102: Display a control on a terminal in response to a first input performed by a touch object on the terminal.

In this embodiment of the present disclosure, the touch object may be a stylus or a user. A user may directly perform an operation on the terminal by using a stylus or a finger to generate the first input, and the terminal displays the control in response to the first input.

In an example, the control is a floating icon. In an example, the floating icon may be dragged and moved.

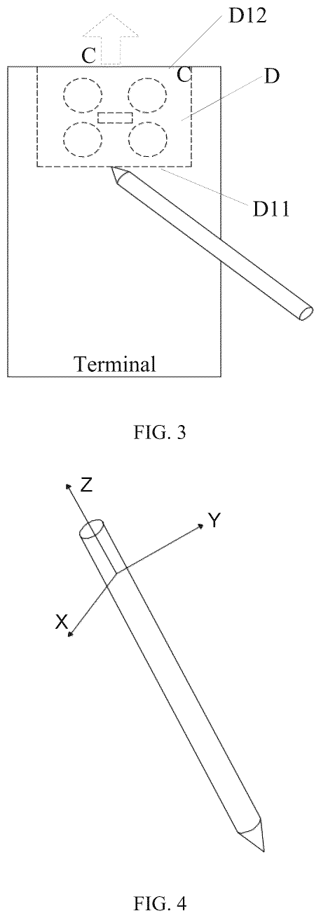

In an example, the control is a window interface corresponding to the flight assembly. The window interface may include a virtual flight assembly board corresponding to the flight assembly. For example, as shown in FIG. 3, a window interface D is a virtual flight assembly board corresponding to the flight assembly shown in FIG. 2. The window interface includes a virtual flight assembly board corresponding to the flight assembly, so that the user can intuitively operate the flight assembly.

Step S104: Control, in response to a second input performed by the touch object on the control, the flight assembly to move towards an outlet.

In an example, the control is a floating icon and the floating icon may be dragged and moved, and the user may drag and move the floating icon towards the outlet by using a stylus or a finger to generate the second input, to control the flight assembly to move synchronously towards the outlet. In other words, a sliding direction of the touch object, a direction in which the floating icon is dragged and moved, and a direction in which the flight assembly moves out of the terminal are consistent, which provides a relatively intuitive operation experience for the user, and is very simple and flexible.

In an example, the control is a window interface corresponding to the flight assembly. The second input is an input generated when the stylus slides from a first board to a second board on the window interface, the first board is a board away from the outlet on the window interface, and the second board is a board close to the outlet on the window interface. Referring to FIG. 3, an outlet C of the terminal is located at the top of the terminal, a window interface D is a virtual flight assembly board, the window interface D is located at the top of a screen interface and is adjacent to the outlet C, and the second input is an input generated when the stylus slides from a first border D11 to a second border D12 on the window interface D, where the first border D11 is a border away from the outlet of the window interface D, and the second border D12 is a border close to the outlet of the window interface. As shown by an arrow in FIG. 3, the stylus slides from the first board D11 to the second board D12, that is, slides towards the outlet C, and in response to this operation, the flight assembly is pushed from the outlet C to the outside of the terminal. In other words, a sliding direction of the touch object is consistent with a direction in which the flight assembly moves out of the terminal, which provides a relatively intuitive operation experience for the user, and is very simple and flexible.

In an example, the second input may be an input generated when the stylus touches and holds the first border of the window interface and then slides to the second border. That the stylus touches and holds the first border of the window interface means that the stylus taps the first border and duration exceeds preset duration.

In an example, the control is a window interface corresponding to the flight assembly. The window interface includes a virtual flight assembly board corresponding to the flight assembly. The flight assembly moves in synchronization with sliding of the stylus, so that when the stylus slides from a first board to a second board, the flight assembly just move out of the terminal. In this manner, the user can better understand an association between a sliding operation of the user and movement of the flight assembly, which gives the user a better operation experience.

Through the method for controlling a flight assembly in this embodiment of the present disclosure, the flight assembly can be flexibly and easily controlled, which is very intuitive and easy to understand and operate by the user.

In some embodiments of this application, the touch object is a stylus. In response to a fourth input generated through touching and holding of the stylus on the window interface, the flight assembly is controlled to establish a communication connection to the stylus. For example, the stylus taps a center position of the window interface and tapping duration exceeds preset duration. In some implementations, in response to a fifth input generated through continuous tapping of the stylus on the window interface, the flight assembly is controlled to establish a communication connection to the stylus. For example, the stylus continuously taps a center position of the window interface. After the communication connection is established between the flight assembly and the stylus, information exchange may be directly performed between the flight assembly and the stylus, for example, sending and receiving of instructions, sending and receiving of sensing data, and sending and receiving of attitude data.

Step S106: Control a flight action of the flight assembly according to an action of the touch object after the flight assembly moves out of the terminal.

In some embodiments of this application, before the controlling a flight action of the flight assembly according to an action of the touch object after the flight assembly moves out of the terminal, the flight assembly is controlled to fly to a preset altitude to hover. In other words, after moving out of the terminal, the flight assembly first flies to the preset altitude to hover, and waits for a flight control command of the user. The preset altitude may be an altitude set by the user. For example, the preset altitude may be one meter above the terminal or two meters above the ground. In an example, the flight assembly stores a preset program, and under control of the preset program, the flight assembly automatically flies to the preset altitude to hover after moving out of the terminal.

The action of the touch object may be translation and rotation. In an example, the touch object is a user, and a wearable device is worn on the user. Before the controlling a flight action of the flight assembly according to an action of the touch object after the flight assembly moves out of the terminal, a sensing signal of a target sensor in the wearable device that is worn on the user is obtained, and the action of the touch object is determined according to the sensing signal. In an example, the touch object is a stylus, and before the controlling a flight action of the flight assembly according to an action of the touch object, an action of the stylus may be determined by using the sensing signal output by the sensor mounted in the stylus.

The following describes an embodiment in which the flight assembly is controlled to translate after the flight assembly is pushed out of the terminal.

In an embodiment of this application, a process of controlling the flight assembly to translate according to the action of the touch object includes steps S202 to S204.

Step S202: Detect a translation direction and a translation distance of the touch object, and determine a target translation direction and a target translation distance of the flight assembly according to the translation direction and the translation distance of the touch object.

The translation direction of the touch object is a direction in which the touch object moves in space, and the translation distance of the touch object is a distance that the touch object moves in space. For example, if the touch object moves one meter eastward, the translation direction of the touch object is east, and the translation distance is one meter.

The target translation direction of the flight assembly is consistent with the translation direction of the touch object. When the user wants to translate the flight assembly eastward, the user may perform an operation of translating the touch object eastward. When the user wants to translate the flight assembly southward, the user may perform an operation of translating the touch object southward.

The target translation distance of the flight assembly may be a preset multiple of the translation distance of the touch object. For example, the preset multiple is n times, and n≥1. When the user controls that the translation distance of the touch object is P, the target translation distance of the flight assembly is a product of P and n.

Step S204: Control the flight assembly to translate according to the target translation direction and the target translation distance.

The following describes an embodiment in which the flight assembly is controlled to rotate after the flight assembly is pushed out of the terminal.

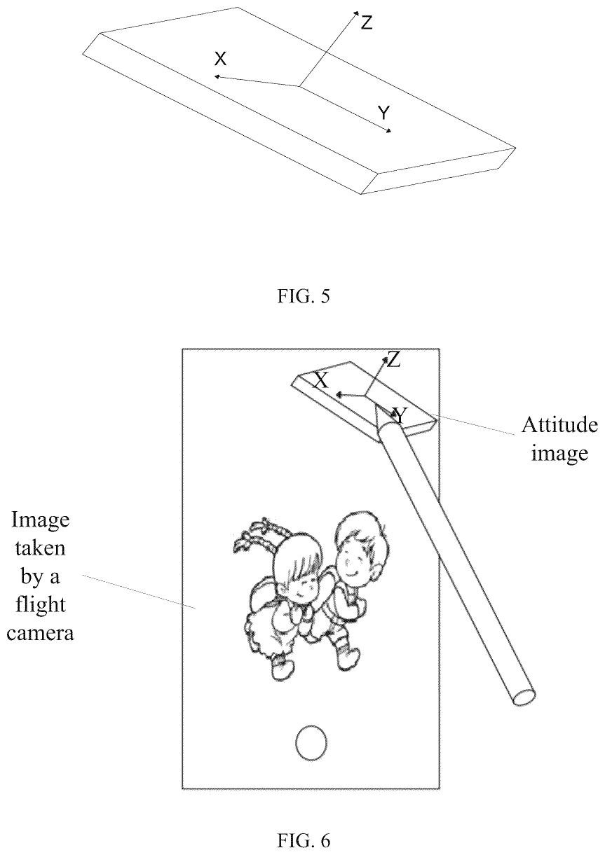

First, a coordinate system of the stylus and a body coordinate system of the flight assembly are described. Referring to FIG. 4, the coordinate system of the stylus is a three-dimensional orthogonal rectangular coordinate system, a Z-axis of the stylus is a coordinate axis in a longitudinal direction of a stylus body, and a forward direction of the Z-axis of the stylus is a tip of the stylus pointing to a tail of the stylus. Referring to FIG. 5, the body coordinate system is a three-dimensional orthogonal rectangular coordinate system on an aircraft, and an origin of the body coordinate system is located in a center of mass of the aircraft.

In an embodiment of this application, a process of controlling the flight assembly to rotate according to the action of the touch object includes steps S302 to S304.

Step S302: Detect a rotation direction and a rotation angle of the touch object, and determine a target rotation direction and a target rotation angle of the flight assembly according to the rotation direction and the rotation angle of the touch object.

The rotation angle of the touch object is an angle at which the touch object rotates in space, and the rotation direction of the touch object is a direction in which the touch object rotates in space.

The target rotation angle of the flight assembly may be consistent with the rotation angle of the touch object, or the target rotation angle of the flight assembly may be a preset multiple of the rotation angle of the touch object.

The target rotation direction of the flight assembly is consistent with the rotation direction of the touch object. For example, in a case that the touch object is a stylus, a Z-axis of the stylus is a coordinate axis in a longitudinal direction of a stylus body, the Z-axis of the stylus is a default rotation axis of the stylus, and a rotation direction of the stylus is whether the stylus rotates clockwise or counterclockwise from a negative direction of the Z-axis of the stylus to a forward direction of the Z-axis of the stylus. For example, in a case that the touch object is a user, a height direction of the user is a direction of a rotation axis by default, and the rotation direction of the touch object is whether the touch object rotates clockwise or counterclockwise when viewed from above the user. The rotation direction of the flight assembly is whether the flight assembly rotates clockwise or counterclockwise from a negative direction of a target axis of the flight assembly to a forward direction of the target axis of the flight assembly. In this disposing manner, the target rotation direction of the flight assembly is consistent with the rotation direction of the touch object, to control the flight assembly to perform corresponding rotation through rotation of the touch object.

Step S304: Control the flight assembly to rotate according to the target rotation direction and the target rotation angle by using a target axis as a rotation axis.

In an embodiment of this application, the touch object is a stylus, and a process of controlling the flight assembly to rotate according to the action of the touch object includes steps S402 to S404.

Step S402: Detect a rotation angle of the stylus with a longitudinal direction of a stylus body as a rotation axis, and determine a target rotation angle of the flight assembly according to the rotation angle; and detect a rotation direction of the stylus with the longitudinal direction of the stylus body as a rotation axis, and determine a target rotation direction of the flight assembly according to the rotation direction.

Through a sensor mounted in the stylus, the rotation angle and the rotation direction may be detected with the longitudinal direction of the stylus body as the rotation axis. The rotation angle of the stylus with the longitudinal direction of the stylus body as the rotation axis is a rotation angle of the stylus with a Z-axis as a rotation axis. When the stylus rotates with the longitudinal direction of the stylus body as the rotation axis, the rotation direction of the stylus is whether the stylus rotates clockwise or counterclockwise from a negative direction of the Z-axis of the stylus to a positive direction of the Z-axis of the stylus.

The target rotation angle of the flight assembly may be consistent with the rotation angle of the stylus. For example, if the rotation angle of the stylus with the longitudinal direction of the stylus body as the rotation axis is 180 degrees, the target rotation angle of the flight assembly is also 180 degrees. In some implementations, the target rotation angle of the flight assembly may be a preset multiple of the rotation angle of the stylus. The preset multiple is, for example, m times, and m≥1. When the user controls that the rotation angle with the longitudinal direction of the stylus body as the rotation axis is Q, the target rotation angle of the flight assembly is a product of Q and m.

Step S404: Control the flight assembly to rotate according to the target rotation direction and the target rotation angle by using a target axis as a rotation axis.

In an example, the target rotation direction in which the flight assembly rotates by using the target axis is consistent with the rotation direction of the stylus with the longitudinal direction of the stylus body as the rotation axis.

When the stylus rotates with the longitudinal direction of the stylus body as the rotation axis, the rotation direction of the stylus is whether the stylus rotates clockwise or counterclockwise from a negative direction of the Z-axis of the stylus to a positive direction of the Z-axis of the stylus. When the flight assembly rotates by using an X-axis of the flight assembly as a rotation axis, the rotation direction of the flight assembly is whether the flight assembly rotates clockwise or counterclockwise from a negative direction of the X-axis of the flight assembly to a forward direction of the X-axis of the flight assembly. When the flight assembly rotates by using a Y-axis of the flight assembly as a rotation axis, the rotation direction of the flight assembly is whether the flight assembly rotates clockwise or counterclockwise from a negative direction of the Y-axis of the flight assembly to a forward direction of the Y-axis of the flight assembly. When the flight assembly rotates by using a Z-axis of the flight assembly as a rotation axis, the rotation direction of the flight assembly is whether the flight assembly rotates clockwise or counterclockwise from a negative direction of the Z-axis of the flight assembly to a forward direction of the Z-axis of the flight assembly.

If it is detected that the rotation direction of the stylus with the longitudinal direction of the stylus body as the rotation axis is clockwise rotation, the target rotation direction in which the flight assembly rotates by using the target axis as the rotation axis is also clockwise rotation. If it is detected that the rotation direction of the stylus with the longitudinal direction of the stylus body as the rotation axis is counterclockwise rotation, the target rotation direction in which the flight assembly rotates by using the target axis as the rotation axis is also counterclockwise rotation.

In an embodiment of this application, the target axis of the flight assembly is the Z-axis of the flight assembly by default, and the user may manually change the target axis of the flight assembly.

In an embodiment of this application, the terminal provides a setting interface of the target axis of the flight assembly, and the user may set any coordinate axis of the flight assembly as the target axis on the setting interface.

In an embodiment of this application, the target axis of the flight assembly is determined by using steps S502 to S506.

Step S502: Obtain attitude data of the flight assembly.

The attitude data of the flight assembly may be obtained through a sensor mounted in the flight assembly, to determine an attitude of the flight assembly.

Step S504: Display an attitude image of the flight assembly on the terminal according to the attitude data of the flight assembly, where the attitude image includes a body coordinate system of the flight assembly.

The attitude image of the flight assembly is an attitude image in which the flight assembly is currently located. The terminal may receive an image photographed in real time by the flight assembly and display the image, and simultaneously display the attitude image of the flight assembly, so as to more intuitively understand a relationship between a current attitude of the flight assembly and a real-time image photographed by the flight assembly, and understand a rotation manner in which a desired rotation result can be implemented. Referring to FIG. 6, the terminal displays a real-time image currently photographed by the flight assembly and the attitude image of the flight assembly, and the attitude image displays the body coordinate system of the flight assembly.

Step S506: Select one coordinate axis of the flight assembly as the target axis in response to a third input performed by the touch object on the attitude image.

Referring to FIG. 6, the third input is an input generated when the user selects one coordinate axis of the flight assembly from the attitude image of the flight assembly displayed in the terminal, and the selected coordinate axis is determined as the target axis. The third input is, for example, an input generated when the stylus taps one coordinate axis of the body coordinate system in the attitude image of the flight assembly. For example, if the user taps a Y coordinate axis of the body coordinate system in the attitude image by using the stylus, the Y coordinate axis of the flight assembly is determined as the target axis.

In this example, the attitude image of the flight assembly is displayed on the terminal, so that the user performs selection, which is more intuitive and convenient for the user to operate.

In an embodiment of this application, the target axis of the flight assembly is determined by using steps S602 to S606.

Step S602: Obtain attitude data of the stylus and attitude data of the flight assembly.

The attitude data of the flight assembly may be obtained through a sensor mounted in the flight assembly, to determine an attitude of the flight assembly.

Step S604: Determine a first coordinate axis of the flight assembly according to the attitude data of the stylus and the attitude data of the flight assembly, where the first coordinate axis of the flight assembly is a coordinate axis that is in a body coordinate system of the flight assembly and that forms an acute angle of less than 45 degrees with a longitudinal direction of a stylus body of the stylus.

In three axes in the body coordinate system of the flight assembly, if an acute angle between a specified axis and the longitudinal direction of the stylus body of the stylus is less than 45 degrees, it indicates that the coordinate axis and a Z axis of the stylus are more approximately parallel in space, and the coordinate axis is used as the first coordinate axis of the flight assembly.

Step S606: Determine the first coordinate axis of the flight assembly as the target axis.

In this example, the coordinate axis that is of the flight assembly and that is more parallel to the stylus is set as the first coordinate axis. The user can set the target axis of the flight assembly only by adjusting an attitude of the stylus. This manner is convenient and intuitive, and facilitates operation by the user.

In an example, the controlling a flight action of the flight assembly according to an action of the touch object includes the following steps:

Step S702: Generate a flight instruction according to the action of the touch object.

Step S704: Obtain an average moving speed of the touch object within a preset time before the flight instruction is generated.

Step S706: In a case that the average moving speed is less than or equal to a preset speed threshold, send the flight instruction to the flight assembly, so that the flight assembly flies according to the flight instruction.

In this manner, flight instructions generated through frequent and fast actions of the touch object are filtered out, so that the flight assembly is prevented from receiving frequent and conflicting flight instructions in a short time, thereby avoiding adverse impact on safety of the flight assembly and safety of a surrounding environment.

In an example, the flight instruction is a translation instruction. An average moving speed of the touch object within the preset time before the translation instruction is generated is obtained, and the translation instruction is sent to the flight assembly only in a case that the average moving speed is less than or equal to the preset threshold. In a case that the average moving speed is greater than the preset threshold, this translation instruction is filtered out and is not sent to the flight assembly. The preset time and the preset threshold may be set according to an actual situation, the preset time may be, for example, 3 seconds, and the preset threshold may be, for example, 1 meter per second.

In an example, the flight instruction is a rotation instruction. An average moving speed of the touch object within the preset time before the rotation instruction is generated is obtained, and the rotation instruction is sent to the flight assembly only in a case that the average moving speed is less than or equal to the preset threshold. In a case that the average moving speed is greater than the preset threshold, the rotation instruction is filtered out and is not sent to the flight assembly. The preset time and the preset threshold may be set according to an actual situation, the preset time may be, for example, 3 seconds, and the preset threshold may be, for example, 1 meter per second.

In an example, after the flight assembly moves out of the terminal, a flight control interface is displayed on the terminal, and the flight action of the flight assembly is controlled in response to an input performed by the touch object on the flight control interface. For example, a “translate” control and a “rotate” control are disposed on the flight control interface. The touch object taps the “translate” control on the flight interface, and the target translation direction and the target translation distance are input to control the flight assembly to translate. The touch object taps the “rotate” control, and the target axis, the target rotation direction, and the target rotation angle are input to control the flight assembly to translate.

In some implementation examples of this application, all or a part of the steps in the foregoing method embodiment for controlling a flight assembly may be applied to the foregoing terminal, and are performed by the foregoing terminal. For example, the foregoing steps S102 to S104 may be performed by the terminal. In some implementation examples of this application, after the flight assembly is pushed out of the terminal, all or a part of the steps related to controlling the flight assembly to translate/rotate may be performed by the stylus or the wearable device.

In this embodiment of this application, the flight assembly is controlled based on the touch object; the control is displayed on the terminal in response to the first input performed by the touch object on the terminal; in response to the second input performed by the touch object on the control, the flight assembly is controlled to move towards the outlet; and the flight assembly is controlled to perform the corresponding flight action according to the action of the touch object after the flight assembly moves out of the terminal. Through the control manner in this embodiment of the present disclosure, the flight assembly can be flexibly and easily controlled, which is very intuitive and easy to understand and operate by the user.

According to the method for controlling a flight assembly provided in this embodiment of this application, the flight assembly may be controlled together with the terminal and the stylus, and a complete set of control solutions including pushing out the flight assembly from the terminal, translating the flight assembly after the flight assembly is detached from the terminal, and rotating the flight assembly is proposed, so that the flight assembly can be flexibly and easily controlled, which is very intuitive and easy to understand and operate by the user.

It should be noted that, the method for controlling a flight assembly provided in the embodiments of this application may be performed by an apparatus for controlling a flight assembly. In the embodiments of this application, an example in which the apparatus for controlling a flight assembly performs the method for controlling a flight assembly is used to describe the apparatus for controlling a flight assembly provided in the embodiments of this application.

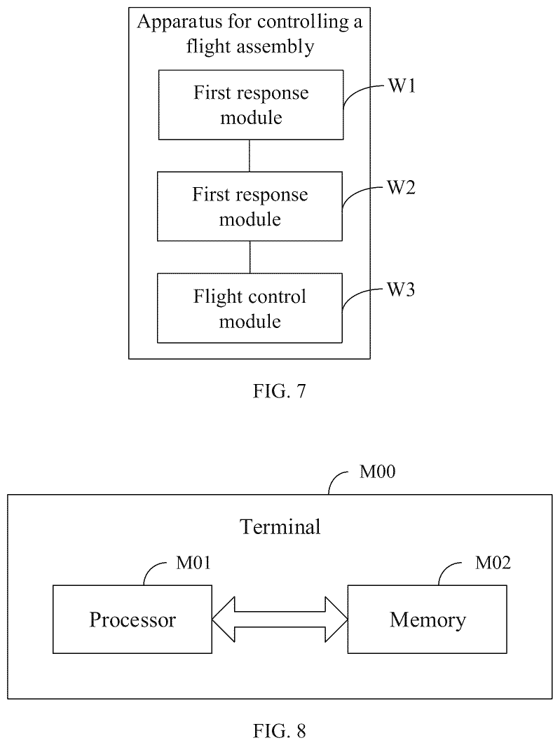

An embodiment of this application provides an apparatus for controlling a flight assembly. Referring to FIG. 7, the apparatus for controlling a flight assembly includes a first response module W1, a second response module W2, and a flight control module W3.

The first response module W1 is configured to display a control on a terminal in response to a first input performed by a touch object on the terminal.

The second response module W2 is configured to control, in response to a second input performed by the touch object on the control, the flight assembly to move towards the outlet.

The flight control module W3 is configured to control a flight action of the flight assembly according to an action of the touch object after the flight assembly moves out of the terminal.

In an example, the apparatus further includes a hover control module. The hover control module is configured to: before the controlling a flight action of the flight assembly according to an action of the touch object after the flight assembly moves out of the terminal, control the flight assembly to fly to a preset altitude to hover.

In an example, the touch object is a user, and the apparatus further includes a touch object action determining module. The touch object action determining module is configured to: before the controlling a flight action of the flight assembly according to an action of the touch object after the flight assembly moves out of the terminal, obtain a sensing signal of a target sensor that is worn on a wearable device of the user, and determine the action of the touch object according to the sensing signal.

In an example, the controlling a flight action of the flight assembly according to an action of the touch object includes: detecting a translation direction and a translation distance of the touch object, and determining a target translation direction and a target translation distance of the flight assembly according to the translation direction and the translation distance of the touch object; and controlling the flight assembly to translate according to the target translation direction and the target translation distance.

In an example, the controlling a flight action of the flight assembly according to an action of the touch object includes: detecting a rotation direction and a rotation angle of the touch object, and determining a target rotation direction and a target rotation angle of the flight assembly according to the rotation direction and the rotation angle of the touch object; and controlling the flight assembly to rotate according to the target rotation direction and the target rotation angle by using a target axis as a rotation axis.

In an example, the touch object is a stylus, and the controlling a flight action of the flight assembly according to an action of the touch object includes: detecting a rotation angle of the stylus with a longitudinal direction of a stylus body as a rotation axis, and determining a target rotation angle of the flight assembly according to the rotation angle; detecting a rotation direction of the stylus with the longitudinal direction of the stylus body as a rotation axis, and determining a target rotation direction of the flight assembly according to the rotation direction; and controlling the flight assembly to rotate according to the target rotation direction and the target rotation angle by using a target axis as a rotation axis.

In an example, the apparatus further includes a first target axis determining module. The first target axis determining module is configured to: before the controlling the flight assembly to rotate according to the target rotation direction and the target rotation angle by using a target axis as a rotation axis, obtain attitude data of the flight assembly, and display an attitude image of the flight assembly on the terminal according to the attitude data of the flight assembly, where the attitude image includes a body coordinate system of the flight assembly, and the body coordinate system is a three-dimensional rectangular coordinate system; and select one coordinate axis of the flight assembly as the target axis in response to a third input performed by the touch object on the attitude image.

In an example, the touch object is a stylus, and the apparatus further includes a second target axis determining module. The second target axis determining module is configured to: before the controlling the flight assembly to rotate according to the target rotation direction and the target rotation angle by using a target axis as a rotation axis, obtain attitude data of the stylus and attitude data of the flight assembly, and determine a first coordinate axis of the flight assembly according to the attitude data of the stylus and the attitude data of the flight assembly, where the first coordinate axis of the flight assembly is a coordinate axis that is in a body coordinate system of the flight assembly and that forms an acute angle of less than 45 degrees with a longitudinal direction of a stylus body of the stylus, and the body coordinate system is a three-dimensional rectangular coordinate system; and determine the first coordinate axis of the flight assembly as the target axis.

In an example, the controlling a flight action of the flight assembly according to an action of the touch object includes: generating a flight instruction according to the action of the touch object; obtaining an average moving speed of the touch object within a preset time before the flight instruction is generated; and in a case that the average moving speed is less than or equal to a preset speed threshold, sending the flight instruction to the flight assembly, so that the flight assembly flies according to the flight instruction.

According to the apparatus for controlling a flight assembly provided in this embodiment of this application, the flight assembly is controlled based on the touch object; the control is displayed on the terminal in response to the first input performed by the touch object on the terminal; in response to the second input performed by the touch object on the control, the flight assembly is controlled to move towards the outlet; and the flight assembly is controlled to perform the corresponding flight action according to the action of the touch object after the flight assembly moves out of the terminal. Through the control manner in this embodiment of the present disclosure, the flight assembly can be flexibly and easily controlled, which is very intuitive and easy to understand and operate by the user.

According to the apparatus for controlling a flight assembly provided in this embodiment of this application, the flight assembly may be controlled together with the terminal and the stylus, and a complete set of control solutions including pushing out the flight assembly from the terminal, translating the flight assembly after the flight assembly is detached from the terminal, and rotating the flight assembly is proposed, so that the flight assembly can be flexibly and easily controlled, which is very intuitive and easy to understand and operate by the user.

The apparatus for controlling a flight assembly in this embodiment of this application may be an electronic device, or may be a component in an electronic device, such as an integrated circuit or a chip. The electronic device may be a terminal, or another device other than the terminal. For example, the electronic device may be a mobile phone, a tablet computer, a notebook computer, a palmtop computer, an in-vehicle electronic device, a Mobile Internet Device (MID), an Augmented Reality (AR)/Virtual Reality (VR) device, a robot, a wearable device, an Ultra-Mobile Personal Computer (UMPC), or a netbook or a Personal Digital Assistant (PDA), or may be a server, a Network Attached Storage (NAS), a personal computer, a television, a cabinet or a self-service computer. This is not specifically limited in this embodiment of this application.

The apparatus for controlling a flight assembly in this embodiment of this application may be an apparatus with an operating system. The operating system may be an Android operating system, an iOS operating system, or another possible operating system. This is not specifically limited in this embodiment of this application.

The apparatus for controlling a flight assembly provided in this embodiment of this application can implement the processes implemented in the method embodiments in FIG. 1 to FIG. 6. To avoid repetition, details are not described herein again.

In some implementations, as shown in FIG. 8, an embodiment of this application further provides a terminal M00, including a processor M01 and a memory M02. The memory M02 stores a program or an instruction that can run on the processor M01, and the program or the instruction is executed by the processor M01 to implement the steps of the foregoing method embodiment for controlling a flight assembly, and a same technical effect can be achieved. To avoid repetition, details are not described herein again.

It should be noted that the terminal in this embodiment of this application includes the foregoing mobile electronic device and the foregoing non-mobile electronic device.

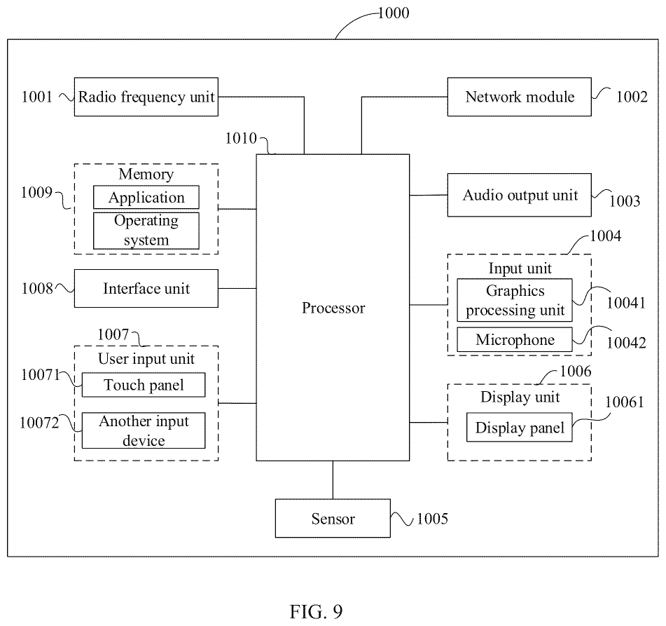

FIG. 9 is a schematic diagram of a hardware structure of an electronic device 1000 according to an embodiment of this application.

The electronic device 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the electronic device 1000 may further include the power supply (for example, a battery) that supplies power to each component. The power supply may be logically connected to the processor 1010 by using a power supply management system, so as to manage functions such as charging, discharging, and power consumption by using the power supply management system. The structure of the electronic device shown in FIG. 9 does not constitute a limitation on the electronic device, and the electronic device may include more or fewer components than those shown in the figure, or combine some components, or have different component arrangements. Details are not described herein again.

The processor 1010 is configured to display a control on the electronic device in response to a first input performed by a touch object on the electronic device; control, in response to a second input performed by the touch object on the control, the flight assembly to move towards the outlet; and control a flight action of the flight assembly according to an action of the touch object after the flight assembly moves out of the electronic device.

In an example, the processor 1010 is further configured to: before the controlling a flight action of the flight assembly according to an action of the touch object after the flight assembly moves out of the electronic device, control the flight assembly to fly to a preset altitude to hover.

In an example, the touch object is a user, and the processor 1010 is further configured to: before the controlling a flight action of the flight assembly according to an action of the touch object after the flight assembly moves out of the electronic device, obtain a sensing signal of a target sensor that is worn on a wearable device of the user, and determine the action of the touch object according to the sensing signal.

In an example, the controlling a flight action of the flight assembly according to an action of the touch object includes: detecting a translation direction and a translation distance of the touch object, and determining a target translation direction and a target translation distance of the flight assembly according to the translation direction and the translation distance of the touch object; and controlling the flight assembly to translate according to the target translation direction and the target translation distance.

In an example, the controlling a flight action of the flight assembly according to an action of the touch object includes: detecting a rotation direction and a rotation angle of the touch object, and determining a target rotation direction and a target rotation angle of the flight assembly according to the rotation direction and the rotation angle of the touch object; and controlling the flight assembly to rotate according to the target rotation direction and the target rotation angle by using a target axis as a rotation axis.

In an example, the touch object is a stylus, and the controlling a flight action of the flight assembly according to an action of the touch object includes: detecting a rotation angle of the stylus with a longitudinal direction of a stylus body as a rotation axis, and determining a target rotation angle of the flight assembly according to the rotation angle; detecting a rotation direction of the stylus with the longitudinal direction of the stylus body as a rotation axis, and determining a target rotation direction of the flight assembly according to the rotation direction; and controlling the flight assembly to rotate according to the target rotation direction and the target rotation angle by using a target axis as a rotation axis.

In an example, the processor 1010 is further configured to: before the controlling the flight assembly to rotate according to the target rotation direction and the target rotation angle by using a target axis as a rotation axis, obtain attitude data of the flight assembly; display an attitude image of the flight assembly on the electronic device according to the attitude data of the flight assembly, where the attitude image includes a body coordinate system of the flight assembly, and the body coordinate system is a three-dimensional rectangular coordinate system; and select one coordinate axis of the flight assembly as the target axis in response to a third input performed by the touch object on the attitude image.

In an example, the touch object is a stylus, and the processor 1010 is further configured to: before the controlling the flight assembly to rotate according to the target rotation direction and the target rotation angle by using a target axis as a rotation axis, obtain attitude data of the stylus and attitude data of the flight assembly; determine a first coordinate axis of the flight assembly according to the attitude data of the stylus and the attitude data of the flight assembly, where the first coordinate axis of the flight assembly is a coordinate axis that is in a body coordinate system of the flight assembly and that forms an acute angle of less than 45 degrees with a longitudinal direction of a stylus body of the stylus, and the body coordinate system is a three-dimensional rectangular coordinate system; and determine the first coordinate axis of the flight assembly as the target axis.

In an example, the controlling a flight action of the flight assembly according to an action of the touch object includes: generating a flight instruction according to the action of the touch object; obtaining an average moving speed of the touch object within a preset time before the flight instruction is generated; and in a case that the average moving speed is less than or equal to a preset speed threshold, sending the flight instruction to the flight assembly, so that the flight assembly flies according to the flight instruction.

According to the electronic device provided in this embodiment of this application, the flight assembly is controlled based on the touch object; the control is displayed on the terminal in response to the first input performed by the touch object on the terminal; in response to the second input performed by the touch object on the control, the flight assembly is controlled to move towards the outlet; and the flight assembly is controlled to perform the corresponding flight action according to the action of the touch object after the flight assembly moves out of the terminal. Through the control manner in this embodiment of the present disclosure, the flight assembly can be flexibly and easily controlled, which is very intuitive and easy to understand and operate by the user.

According to the electronic device provided in this embodiment of this application, the flight assembly may be controlled together with the terminal and the stylus, and a complete set of control solutions including pushing out the flight assembly from the terminal, translating the flight assembly after the flight assembly is detached from the terminal, and rotating the flight assembly is proposed, so that the flight assembly can be flexibly and easily controlled, which is very intuitive and easy to understand and operate by the user.

It should be understood that, in this embodiment of this application, the input unit 1004 may include a Graphics Processing Unit (GPU) 10041 and a microphone 10042, and the graphics processing unit 10041 processes image data of a still image or a video that is obtained by an image capturing apparatus (for example, a camera) in a video capturing mode or an image capturing mode. The display unit 1006 may include a display panel 10061. The display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

The memory 1009 may be configured to store a software program and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1009 in this embodiment of this application includes but is not limited to these memories and a memory of any other proper type.

The processor 1010 may include one or more processing units. In some implementations, an application processor and a modem processor are integrated into the processor 1010. The application processor mainly processes an operating system, a user interface, an application, and the like. The modem processor mainly processes a wireless communication signal, for example, a baseband processor. It can be understood that, in some implementations, the modem processor may not be integrated into the processor 1010.

Through the electronic device in this embodiment of the present disclosure, the flight assembly can be flexibly and easily controlled, which is very intuitive and easy to understand and operate by the user.

An embodiment of this application further provides a readable storage medium. The readable storage medium stores a program or an instruction, and the program or the instruction is executed by a processor to implement the processes of the foregoing method embodiment for controlling a flight assembly, and a same technical effect can be achieved. To avoid repetition, details are not described herein again.

The processor is a processor in the electronic device in the foregoing embodiment. The readable storage medium includes a computer readable storage medium, such as a computer ROM, a RAM, a magnetic disk, or an optical disc.

An embodiment of this application further provides a chip. The chip includes a processor and a communication interface, the communication interface is coupled to the processor, and the processor is configured to run a program or an instruction to implement the processes of any one of the foregoing method embodiments for controlling a flight assembly, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application provides a computer program product. The program product is stored in a storage medium. The program product is executed by at least one processor to implement the processes of the foregoing method embodiment for controlling a flight assembly, and a same technical effect can be achieved. To avoid repetition, details are not described herein again.

It should be noted that, in this specification, the terms “include,” “comprise,” or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A method for controlling a flight assembly, wherein the flight assembly is movably disposed inside a terminal, the terminal is provided with an outlet for the flight assembly to move out of the terminal, and the method comprises:
displaying a control on the terminal in response to a first input performed by a touch object on the terminal;
controlling, in response to a second input performed by the touch object on the control, the flight assembly to move towards the outlet; and
controlling a flight action of the flight assembly according to an action of the touch object after the flight assembly moves out of the terminal.

2. The method according to claim 1, wherein before the controlling a flight action of the flight assembly according to an action of the touch object after the flight assembly moves out of the terminal, the method further comprises:
controlling the flight assembly to fly to a preset altitude to hover.

3. The method according to claim 1, wherein the touch object is a user, and before the controlling a flight action of the flight assembly according to an action of the touch object after the flight assembly moves out of the terminal, the method further comprises:
obtaining a sensing signal of a target sensor that is worn on a wearable device of the user; and
determining the action of the touch object according to the sensing signal.

4. The method according to claim 1, wherein the controlling a flight action of the flight assembly according to an action of the touch object comprises:
detecting a translation direction and a translation distance of the touch object, and determining a target translation direction and a target translation distance of the flight assembly according to the translation direction and the translation distance of the touch object; and
controlling the flight assembly to translate according to the target translation direction and the target translation distance.

5. The method according to claim 1, wherein the controlling a flight action of the flight assembly according to an action of the touch object comprises:
detecting a rotation direction and a rotation angle of the touch object, and determining a target rotation direction and a target rotation angle of the flight assembly according to the rotation direction and the rotation angle of the touch object; and
controlling the flight assembly to rotate according to the target rotation direction and the target rotation angle by using a target axis as a rotation axis.

6. The method according to claim 1, wherein the touch object is a stylus, and the controlling a flight action of the flight assembly according to an action of the touch object comprises:
detecting a rotation angle of the stylus with a longitudinal direction of a stylus body as a rotation axis, and determining a target rotation angle of the flight assembly according to the rotation angle;
detecting a rotation direction of the stylus with the longitudinal direction of the stylus body as a rotation axis, and determining a target rotation direction of the flight assembly according to the rotation direction; and
controlling the flight assembly to rotate according to the target rotation direction and the target rotation angle by using a target axis as a rotation axis.

7. The method according to claim 5, wherein before the controlling the flight assembly to rotate according to the target rotation direction and the target rotation angle by using a target axis as a rotation axis, the method further comprises:
obtaining attitude data of the flight assembly;
displaying an attitude image of the flight assembly on the terminal according to the attitude data of the flight assembly, wherein the attitude image comprises a body coordinate system of the flight assembly, and the body coordinate system is a three-dimensional rectangular coordinate system; and
selecting one coordinate axis of the flight assembly as the target axis in response to a third input performed by the touch object on the attitude image.

8. The method according to claim 6, wherein the touch object is a stylus, and before the controlling the flight assembly to rotate according to the target rotation direction and the target rotation angle by using a target axis as a rotation axis, the method further comprises:
obtaining attitude data of the stylus and attitude data of the flight assembly;
determining a first coordinate axis of the flight assembly according to the attitude data of the stylus and the attitude data of the flight assembly, wherein the first coordinate axis of the flight assembly is a coordinate axis that is in a body coordinate system of the flight assembly and that forms an acute angle of less than 45 degrees with a longitudinal direction of a stylus body of the stylus, and the body coordinate system is a three-dimensional rectangular coordinate system; and
determining the first coordinate axis of the flight assembly as the target axis.

9. The method according to claim 4, wherein the controlling a flight action of the flight assembly according to an action of the touch object comprises:
generating a flight instruction according to the action of the touch object;
obtaining an average moving speed of the touch object within a preset time before the flight instruction is generated; and
when the average moving speed is less than or equal to a preset speed threshold, sending the flight instruction to the flight assembly, so that the flight assembly flies according to the flight instruction.

10. A terminal, comprising:
a memory storing computer-readable instructions; and
a processor coupled to the memory and configured to execute the computer-readable instructions, wherein the computer-readable instructions, when executed by the processor, cause the processor to perform operations comprising:
displaying a control on the terminal in response to a first input performed by a touch object on the terminal;
controlling, in response to a second input performed by the touch object on the control, a flight assembly to move towards an outlet; and
controlling a flight action of the flight assembly according to an action of the touch object after the flight assembly moves out of the terminal.

11. The terminal according to claim 10, wherein before the controlling a flight action of the flight assembly according to an action of the touch object after the flight assembly moves out of the terminal, the operations further comprise:
controlling the flight assembly to fly to a preset altitude to hover.

12. The terminal according to claim 10, wherein the touch object is a user, and before the controlling a flight action of the flight assembly according to an action of the touch object after the flight assembly moves out of the terminal, the operations further comprise:
obtaining a sensing signal of a target sensor that is worn on a wearable device of the user; and
determining the action of the touch object according to the sensing signal.

13. The terminal according to claim 10, wherein the controlling a flight action of the flight assembly according to an action of the touch object comprises:
detecting a translation direction and a translation distance of the touch object, and determining a target translation direction and a target translation distance of the flight assembly according to the translation direction and the translation distance of the touch object; and
controlling the flight assembly to translate according to the target translation direction and the target translation distance.

14. The terminal according to claim 10, wherein the controlling a flight action of the flight assembly according to an action of the touch object comprises:
detecting a rotation direction and a rotation angle of the touch object, and determining a target rotation direction and a target rotation angle of the flight assembly according to the rotation direction and the rotation angle of the touch object; and
controlling the flight assembly to rotate according to the target rotation direction and the target rotation angle by using a target axis as a rotation axis.

15. The terminal according to claim 10, wherein the touch object is a stylus, and the controlling a flight action of the flight assembly according to an action of the touch object comprises:
detecting a rotation angle of the stylus with a longitudinal direction of a stylus body as a rotation axis, and determining a target rotation angle of the flight assembly according to the rotation angle;
detecting a rotation direction of the stylus with the longitudinal direction of the stylus body as a rotation axis, and determining a target rotation direction of the flight assembly according to the rotation direction; and
controlling the flight assembly to rotate according to the target rotation direction and the target rotation angle by using a target axis as a rotation axis.

16. The terminal according to claim 14, wherein before the controlling the flight assembly to rotate according to the target rotation direction and the target rotation angle by using a target axis as a rotation axis, the operations further comprise:
obtaining attitude data of the flight assembly;
displaying an attitude image of the flight assembly on the terminal according to the attitude data of the flight assembly, wherein the attitude image comprises a body coordinate system of the flight assembly, and the body coordinate system is a three-dimensional rectangular coordinate system; and
selecting one coordinate axis of the flight assembly as the target axis in response to a third input performed by the touch object on the attitude image.

17. The terminal according to claim 15, wherein the touch object is a stylus, and before the controlling the flight assembly to rotate according to the target rotation direction and the target rotation angle by using a target axis as a rotation axis, the operations further comprise:
obtaining attitude data of the stylus and attitude data of the flight assembly;
determining a first coordinate axis of the flight assembly according to the attitude data of the stylus and the attitude data of the flight assembly, wherein the first coordinate axis of the flight assembly is a coordinate axis that is in a body coordinate system of the flight assembly and that forms an acute angle of less than 45 degrees with a longitudinal direction of a stylus body of the stylus, and the body coordinate system is a three-dimensional rectangular coordinate system; and
determining the first coordinate axis of the flight assembly as the target axis.

18. The terminal according to claim 13, wherein the controlling a flight action of the flight assembly according to an action of the touch object comprises:
generating a flight instruction according to the action of the touch object;
obtaining an average moving speed of the touch object within a preset time before the flight instruction is generated; and
when the average moving speed is less than or equal to a preset speed threshold, sending the flight instruction to the flight assembly, so that the flight assembly flies according to the flight instruction.

19. A non-transitory computer-readable medium storing instructions that, when executed by a processor of a terminal, cause the processor to perform operations comprising:
displaying a control on the terminal in response to a first input performed by a touch object on the terminal;
controlling, in response to a second input performed by the touch object on the control, a flight assembly to move towards an outlet; and
controlling a flight action of the flight assembly according to an action of the touch object after the flight assembly moves out of the terminal.

20. The non-transitory computer-readable medium according to claim 19, wherein before the controlling a flight action of the flight assembly according to an action of the touch object after the flight assembly moves out of the terminal, the operations further comprise:
controlling the flight assembly to fly to a preset altitude to hover.
